(19) United States
(12) Patent Application Publication
(10) Pub. No.: US 2007/0153678 A1
(43) Pub. Date: Jul. 5, 2007

(54) Method for managing broken node in wireless personal area network game

(75) Inventor: Ji-tae Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/514,835

(22) Filed: Sep. 5, 2006

(30) Foreign Application Priority Data
Jan. 2, 2006 (KR) 10-2006-0000142

(51) Int. Cl. H04J 1/16

(52) U.S. Cl. 370/216

(57) ABSTRACT

A method for managing a broken node in a wireless personal area network (WPAN) game includes broadcasting alive check data for checking states of nodes from a master node having opened the WPAN game in a standby state of the WPAN game; receiving alive response data to the alive check data from the nodes; and having not received the alive response data from one of the nodes, determining that node as a broken node and broadcasting information as to the broken node to the other nodes. Other methods for managing a broken node in a WPAN game are also provided.

### CROSS-REFERENCE TO RELATED APPLICATIONS

This application claims priority from Korean Patent Application No. 10-2006-0000142, filed Jan. 2, 2006, in the Korean Intellectual Property Office, the disclosure of which is incorporated herein by reference.

### BACKGROUND OF THE INVENTION

1. Field of the Invention

Apparatuses and methods consistent with the present invention relate to managing a broken node in a wireless personal area network (WPAN) game and, more particularly, to managing a broken node in a WPAN game by which, when a plurality of nodes form a game network to execute a wireless game in a WPAN including a Bluetooth® or ZigBee™ communication, but the wireless game is unable to be executed due to a breakage of an arbitrary node or a communication error, the corresponding broken node can be excluded to continuously execute the WPAN game.

2. Description of the Related Art

In general, game programs popular with users have been applied to a WPAN that is standardized as a short distance wireless network by the IEEE 802.15 Working Group and serviced to the users.

FIGS. 1A and 1B are views illustrating a related art WPAN to which a game program is applied.

In a case where a network game is executed in the conventional WPAN, nodes desiring to participate in the network game may access a fixed game server to execute the network game or may form an independent personal area network (PAN) without the fixed game server to execute the network game.

In the network game using the fixed game server, the fixed game server typically manages all of the nodes participating in the network game at a given time. In the network game executed in the independent PAN without the fixed game server, one of the nodes participating in the network game must be managed so as to serve as a game server.

As shown in FIGS. 1A and 1B, a game network of an independent PAN is formed without a fixed game server. In other words, FIG. 1A shows a standby state of a network game, and FIG. 1B shows an execution state of the network game.

Referring to FIG. 1A, the game network includes a master node M having opened the network game and a plurality of nodes 2, 3, 4, and 5 participating in the network game. In a case where the master node M is broken in the standby state of the network game as shown in FIG. 1A, the network game cannot start. Thus, it is impossible for other nodes to check a state of the broken node. Thus, the network game cannot be executed.

In a case where the node 3 is broken during the execution of the network game as shown in FIG. 1B, the nodes M, 2, 3, 4, and 5 must sequentially execute the network game. However, the network game is interrupted in a turn of the broken node 3. Thus, the network game cannot proceed to a next turn.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method for managing a broken node in a WPAN game by which, when a plurality of nodes form a game network to execute a wireless game in a WPAN including a Bluetooth® or ZigBee™ communication, but the wireless game is unable to be executed due to a breakage of an arbitrary node or a communication error, the corresponding broken node can be excluded to continuously execute the WPAN game.

According to an aspect of the present invention, there is provided a method for managing a broken node in a WPAN game, including: broadcasting alive check data for checking states of nodes from a master node having opened the WPAN game in a standby state of the WPAN game; receiving alive response data to the alive check data from the nodes; and having not received the alive response data from one of the nodes, determining that node as a broken node and broadcasting information as to the broken node to the other nodes.

If an arbitrary node does not transmit the alive response data, the alive check data may be broadcast three times, if the arbitrary node does not transmit the alive response data after the alive check data is broadcast three times, the arbitrary node may be determined as a broken node, and broken announcement data for announcing that the arbitrary node is the broken node may be broadcast to the other nodes.

According to another aspect of the present invention, there is provided a method for managing a broken node in a WPAN game, including: determining whether alive check data has been received from a master node having opened the WPAN game, in a standby state of the WPAN game; and if the alive check data is not received during counting of a predetermined time, determining the master node as a broken node. The method may further include announcing from a node having first recognized the master node as being broken to other nodes that the master node is the broken node and succeeding the master node to perform at least one function of the master node.

The predetermined time may be counted using a timer.

According to another aspect of the present invention, there is provided a method for managing a broken node in a WPAN game, including: broadcasting game data executed by a node in a current turn according to an order of the WPAN game to other nodes in an execution state of the WPAN game; determining whether response data to the game data has been received from all of the other nodes; and recognizing a node not transmitting the response data as a broken node and broadcasting information as to the broken node to the other nodes.

According to another aspect of the present invention, there is provided a method for managing a broken node in a WPAN game, including: determining whether game data has been received from a node in a previous turn according to an order of the WPAN game in an execution state of the WPAN game; and if the game data is not received from the node in the previous turn during counting of a predetermined time, determining the node in the previous turn as a broken node.

Broken announcement data for announcing that the node in the previous turn is the broken node may be broadcast to other nodes and game data executed by the node in the previous turn according to an order of the WPAN game may be broadcast to the other nodes.

### BRIEF DESCRIPTION OF THE DRAWINGS

The above aspects of the present invention will be more apparent by describing certain exemplary embodiments of the present invention with reference to the accompanying drawings, in which:

FIGS. 1A and 1B are views illustrating a related art WPAN to which a game program is applied;

FIGS. 2A and 2B are views of a WPAN game network illustrating a method for managing a broken node according to an exemplary embodiment of the present invention; and

FIGS. 3A and 3B are views of a WPAN game network in which a network game is in an execution state in a method for managing a broken node according to an exemplary embodiment of the present invention.

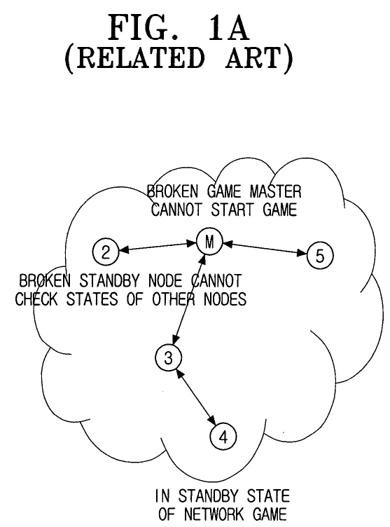

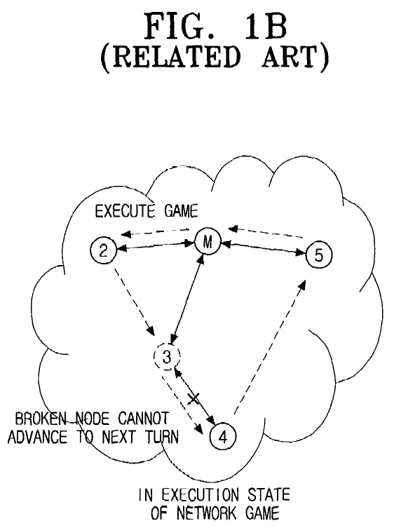

### DETAILED DESCRIPTION OF THE EXEMPLARY EMBODIMENTS

Certain exemplary embodiments of the present invention will be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

A WPAN according to an exemplary embodiment of the present invention may be standardized by IEEE 802.15.4 and may be applied to a low rate WPAN of 250 Kbps or less called ZigBee™.

ZigBee™ transmits a smaller amount of data than IEEE 802.15.1 Bluetooth® but can be used with one battery for one year. Also, ZigBee™ costs half of the IEEE 802.15.1 Bluetooth® to minimize software-related parts and is wireless communication technology suitable for a home network based on controls and sensors. In addition, ZigBee™ can support many more components than IEEE 802.15.1 Bluetooth®.

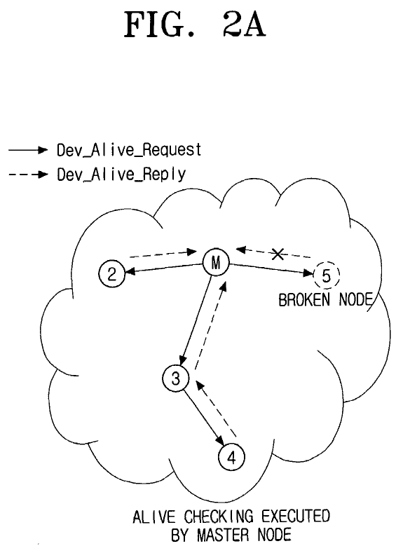

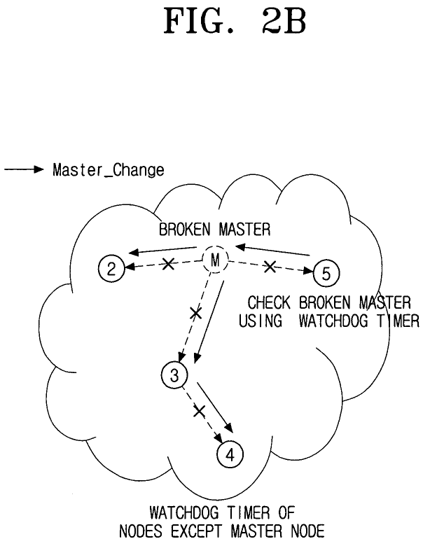

FIGS. 2A and 2B are views of a WPAN game network illustrating a method for managing a broken node according to an exemplary embodiment of the present invention.

As shown in FIGS. 2A and 2B, the WPAN game network according to the present invention includes a master node M opening a network game and a plurality of nodes 2, 3, 4, and 5 participating in the network game.

Referring to FIGS. 2A and 2B, the master node M and the plurality of nodes 2, 3, 4, and 5 form an independent PAN and manage a broken node in a standby state of the network game before starting the network game.

Referring to FIG. 2A, in the standby state of the network game, the master node M periodically broadcasts alive check data Dev_Alive_Request to the plurality of nodes 2, 3, 4, and 5 to check states of the plurality of nodes 2, 3, 4, and 5 so as to check whether the nodes 2, 3, 4, and 5 are alive.

The nodes 2, 3, 4, and 5 transmit alive response data Dev_Alive_Reply to master node M in reply to the alive check data Dev_Alive_Request.

Thus, the master node M checks whether it has received the alive response data Dev_Alive_Reply from all of the nodes 2, 3, 4, and 5 participating in the network game.

Here, in a case where the fifth node 5 is broken as shown in FIG. 2A, the fifth node 5 fails to transmit the alive response data Dev_Alive_Reply to the master node M. The nodes 2, 3, and 4 transmit the alive response data Dev_Alive_Reply to the master node M in reply to the alive check data Dev_Alive Request in a unicast way.

If the master node M does not receive the alive response data Dev_Alive_Reply from the fifth node 5, the master node M broadcasts the alive check data Dev_Alive_Request to the fifth node 5 three times. If the master node M broadcasts the alive check data Dev_Alive_Request to the fifth node 5 three times but does not receive a response to the alive check data Dev_Alive_Request from the fifth node 5, the master node M determines that the fifth node 5 as a broken node. Also, the master node M broadcasts broken announcement data Broken_Chg_annce to the nodes 2, 3, and 4 so as to announce that the fifth node 5 is broken.

Thus, the master node M and the nodes 2, 3, and 4—except the fifth node 5 as the broken node—execute the network game.

Referring to FIG. 2B, the master node M having opened the network game is broken in the standby state of the network game.

As described above, the nodes 2, 3, 4, and 5—except the master node M—periodically receive the alive check data Dev_Alive_Request from the master node M. Thus, when the nodes 2, 3, 4, and 5 count predetermined times using a watchdog timer, the nodes 2, 3, 4, and 5 determine whether the master node M transmits the alive check data Dev_Alive_Request.

While an arbitrary node counts a predetermined time, for example, 10 seconds, using a watchdog timer, the master node M may not transmit data. In this case, the arbitrary node transmits check data one time and then stands by for 5 seconds. If there is no response for 5 seconds, the arbitrary node determines that the master node M is broken. Here, a node that has first identified the master node M as being broken through a watchdog timer announces to other nodes that the master node M is broken.

Thus, the arbitrary node broadcasts broken announcement data Master_Change for announcing that the master node M is broken to the other nodes and succeeds the master node M to perform at least one function of master node M.

Here, in a case where a third node of the plurality of nodes 2, 3, 4, and 5 operates as a coordinator, a second node may directly transmit data to the coordinator. However, the coordinator may not directly transmit data to the second node.

In a case where the coordinator desires to transmit the data to the second node, the coordinator does not directly transmit the data to the second node but announces an existence of the data through a beacon frame in a ZigBee™ communication. Next, an address of the second node corresponding to a pending address field of the beacon frame is recorded. Thus, the corresponding second node having received the beacon frame recognizes that there is data to be received and then transmits a data request command to the coordinator. As a result, the coordinator transmits an acknowledgement (Ack) signal to the second node. The coordinator transmits data to other nodes through this process.

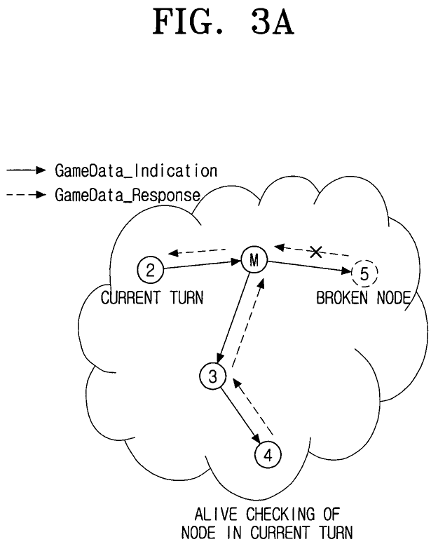

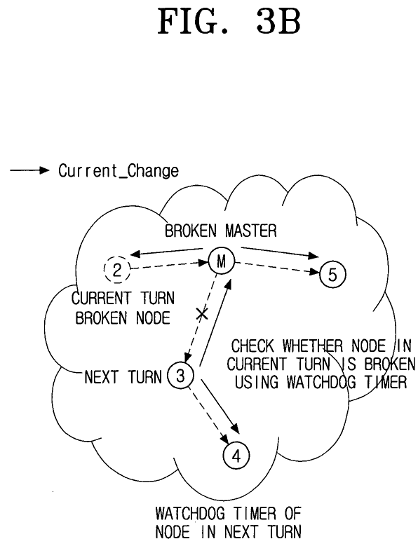

FIGS. 3A and 3B are views of a WPAN game network in which a network game is in an execution state in a method for managing a broken node according to an exemplary embodiment of the present invention.

As shown in FIGS. 3A and 3B, master node M has opened the network game and a second node 2 is a node in a current turn in an execution state of the network game.

Referring to FIG. 3A, when the network game is executed, the second node 2 transmits game data GameData_Indication executing the network game to nodes M, 3, 4, and 5 according to a current order. The nodes M, 3, 4, and 5 receive the game data GameData_Indication from the second node 2 that is the node in the current turn. Here, the master node M having opened the network game serves as a coordinator relaying the game data GameData_Indication of the second node 2 to the nodes 3, 4, and 5.

The nodes M, 3, 4, and 5, having received the game data GameData_Indication from the second node 2, transmit response data GameData_Response to the second node 2 in reply to the game data GameData_Indication.

Thus, the second node 2 determines whether it has received the response data GameData_Response from all of the nodes M, 3, 4, and 5. Here, in a case where the second node 2 receives the response data GameData_Response from all of the nodes M, 3, 4, and 5, the second node 2 broadcasts data for announcing that a next turn is to advance to other nodes. Thus, a node in a next turn executes the network game.

However, if a fifth node 5 is broken, the fifth node 5 fails to transmit the response data GameData_Response to the second node 2. Thus, if the second node 2 does not receive the response data GameData_Response from the fifth node 5, the second node 2 determines the fifth node 5 as a broken node and announces to nodes M, 3, and 4 that the fifth node 5 is the broken node and a next turn is to advance.

Referring to FIG. 3B, the second node 2 executing a current game according to a current order of the network game as the node in the current turn is broken or the master node M having opened the network game is broken.

In a case where a third node 3 is next to the second node 2 according to the order of the network game, the third node 3 awaits the game data GameData_Indication from the second node 2 in the previous turn. Here, when the third node 3 counts a predetermined time using a watchdog timer, the third node 3 determines whether the second node 2 transmits the game data GameData_Indication.

If the third node 3 determines that the second node 2 does not transmit the game data GameData_Indication during the counting of the predetermined time using the watchdog timer, the third node 3 determines that the second node 2 is broken.

Thus, the third node 3 broadcasts broken announcement data Broken_Chg_annce for announcing that the second node 2 is broken to other nodes, executes the network game according the order of the network game, and broadcasts the game data GameData_Indication to nodes 1, 2, 4, and 5. In other words, if the second node 2 in the previous turn is broken, the third node 3 checks that the second node 2 is broken and compulsorily advances a next turn of the network game to continuously execute the network game.

The nodes 1, 2, 4, and 5, having received the game data GameData_Indication from the third node 3, transmit the response data GameData_Response to the third node 3 in reply to the game data GameData_Indication in a unicast way.

Here, if the master node M serves as the coordinator and the coordinator desires to transmit data to the second node 2 or fifth node 5, the coordinator does not directly transmit the data to the second node 2 or fifth node 5, but announces an existence of the data to be transmitted to the second node 2 or fifth node 5 through a beacon frame. Next, an address of the second node 2 or fifth node 5 corresponding to a pending address field of the beacon frame is recorded. Thus, the second node 2 or fifth node 5, having received the beacon frame, recognizes that there is data to be received and then transmits a data request command to the coordinator. As a result, the coordinator transmits an Ack signal to the second node 2 or fifth node 5. The coordinator transmits data to other nodes through this process.

As described above, according to the exemplary embodiments of the present invention, although a broken node occurs in a standby or execution state of a network game, the network game can be continuously executed with the exclusion of the corresponding broken node. Also, although a node corresponding to a current turn is broken in the execution state of the network game, a node in a next turn can recognize that the node corresponding to the current turn is broken to compulsorily advance the next turn so as to continuously execute the network game without interrupting the network game.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method for managing a broken node in a wireless personal area network (WPAN) game, the method comprising:
broadcasting alive check data for checking states of a plurality of nodes from a master node that opened the WPAN game in a standby state of the WPAN game;
receiving alive response data to the alive check data from the nodes;
determining a node among the plurality of nodes that has not received the alive response data as a broken node; and
broadcasting information regarding the broken node to the other nodes.

2. The method of claim 1, wherein if an arbitrary node among the plurality of nodes does not transmit the alive response data, the alive check data is broadcast three times, and
wherein if the arbitrary node does not transmit the alive response data after the alive check data is broadcast three times, the arbitrary node is determined as a broken node and broken announcement data for announcing that the arbitrary node is the broken node is broadcast to other nodes among the plurality of nodes.

3. A method for managing a broken node in a wireless personal area network (WPAN) game, the method comprising:
determining whether alive check data has been received from a master node that opened the WPAN game, in a standby state of the WPAN game; and
if the alive check data is not received within a predetermined time, determining the master node as a broken node.

4. The method of claim 3, further comprising:
announcing from a node having first recognized the master node as being broken to other nodes that the master node is the broken node and succeeding the master node to perform at least one function of the master node.

5. The method of claim 3, wherein the predetermined time is counted using a timer.

6. A method for managing a broken node in a wireless personal area network (WPAN) game, the method comprising:
broadcasting game data executed by a node in a current turn according to an order of the WPAN game to other nodes in an execution state of the WPAN game;
determining whether response data to the game data has been received from all of the other nodes; and
recognizing a node not transmitting the response data as a broken node and broadcasting information as to the broken node to the other nodes.

7. A method for managing a broken node in a wireless personal area network (WPAN) game, the method comprising:
determining whether game data has been received from a node in a previous turn according to an order of the WPAN game in an execution state of the WPAN game; and
if the game data is not received from the node in the previous turn within a predetermined time, determining the node in the previous turn as a broken node.

8. The method of claim 7, wherein broken announcement data for announcing that the node in the previous turn is the broken node is broadcast to other nodes and game data executed by the node in the previous turn according to an order of the WPAN game is broadcast to the other nodes.

9. The method of claim 7, wherein the predetermined time is counted using a timer.
